(19) United States
(12) Patent Application Publication
(10) Pub. No.: US 2026/0311205 A1
(43) Pub. Date: Oct. 8, 2026

(54) PROACTIVE IDENTIFICATION OF GROUP MEMBERSHIP FOR DISCOUNTED TRANSACTIONS

(71) Applicant: Wells Fargo Bank, N.A., San Francisco, CA (US)

(72) Inventors: Justin Blackburn, Litchfield Park, AZ (US); Brent Finnell, Charlotte, NC (US)

(21) Appl. No.: 19/709,061

(22) Filed: Jun. 16, 2026

Related U.S. Application Data
(63) Continuation of application No. 18/742,522, filed on Jun. 13, 2024.

(51) Int. Cl. G06Q 30/0207; G06Q 20/38

(52) U.S. Cl. CPC G06Q 30/0207; G06Q 20/387

(57) ABSTRACT

A computer system and method for assessing a probability of a user belonging to a class of users eligible for discount. The method comprises determining if a user has self-identified as belonging to a class of users eligible for discount; determining if the user has received a financial transaction from an organization restricted to the class of users; determining if the user is using a financial product restricted to the class of users; determining if a financial account of the user is linked with a financial institution or account restricted to the class of users; reviewing the transaction history to identify transactions made at locations with access limited to the class of users; identifying recurring transactions with values consistent with applied discounts; and determining a score indicating the probability of the user belonging to the class of users eligible for discount.

### BACKGROUND

In the current retail and service environment, various classes of individuals, including but not limited to active-duty service members, reservists, dependents, retirees, first responders, senior citizens, and students, are eligible for discounts, rate reductions, and lower fees. These financial benefits, mandated by certain legislative acts such as the Service Members Civil Relief Act, and voluntary programs offered by businesses, aim to alleviate the cost burdens on these groups. Despite the availability of these programs, a significant number of eligible individuals fail to take advantage of them due to two primary reasons: a lack of self-identification by the individuals and insufficient outreach or notification by the businesses offering the discounts. Consequently, these individuals often miss out on substantial savings and benefits they are entitled to receive.

Existing systems rely heavily on an opt-in model where individuals must actively register and verify their eligibility to access discounts. This approach presents several limitations, including the dependency on user initiative and the restricted scope of transaction analysis to only those who have opted in. Furthermore, businesses offering discounts may not consistently inform eligible individuals, leading to a gap between the availability and utilization of these discounts.

### SUMMARY

Embodiments of the disclosure are directed to a method for assessing a probability of a user belonging to a class of users eligible for discount, including determining if a user has self-identified as belonging to a class of users eligible for discount, determining if the user has been on a receiving end of a financial transaction from an organization restricted to the class of users eligible for discount, determining if the user is using a financial product restricted to the class of users eligible for discount, determining if a financial account of the user is linked with a financial institution or account restricted to the class of users eligible for discount, reviewing a transaction history of the user to identify one or more transactions made at a geographic location with access limited to the class of users eligible for discount, reviewing the transaction history of the user to identify at least one reoccurring transaction having a value consistent with an applied discount limited to the class of users eligible for discount, and determining a score indicating a probability of the user belonging to the class of users eligible for discount.

Embodiments also encompass a computer system for assessing a probability of a user belonging to a class of users eligible for discount. The computer system includes one or more processors and non-transitory computer-readable storage media. When executed by the processors, the instructions stored in the media enable the computer system to perform the following steps: determine if a user has self-identified as belonging to a class of users eligible for discount; determine if the user has been on a receiving end of a financial transaction from an organization restricted to the class of users eligible for discount; determine if the user is using a financial product restricted to the class of users eligible for discount; determine if a financial account of the user is linked with a financial institution or account restricted to the class of users eligible for discount; review a transaction history of the user to identify one or more transactions made at a geographic location with access limited to the class of users eligible for discount; review the transaction history of the user to identify at least one reoccurring transaction having a value consistent with an applied discount limited to the class of users eligible for discount; and determine a score indicating a probability of the user belonging to the class of users eligible for discount.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example of a computer system for assessing a probability of a user belonging to a class of users eligible for discount.

FIG. 2 shows an example server device of the computer system of FIG. 1.

FIG. 3 shows an example method of assessing a probability of a user belonging to a class of users eligible for discount as executed by the system of FIG. 1.

FIG. 4 shows example physical components of the server device of FIG. 2.

### DETAILED DESCRIPTION

This disclosure relates to assessing a probability of a user belonging to a class of users eligible for a discount.

The concept comprises a computing environment with one or more client devices connected to a server device via a network. The server device, which may consist of a single server or a collection of servers, can be equipped with computing resources, including processors and data storage repositories, enabling the client devices to engage in complex tasks involving the receipt and processing of data from various sources configured to assess the probability that a user belongs to a class of users eligible for discounts.

The concept can begin by determining if a user has self-identified as belonging to a discount-eligible class. This can involve assessing the user's profile data, querying for explicit declarations of eligibility, and cross-referencing linked accounts or third-party verification services. Additionally, the concept can analyze uploaded documentation and use provided information to determine the user's age, residence, and other identifying information.

Next, the concept can identify and verify financial transactions from organizations restricted to certain user classes. It can retrieve the user's transaction history, filters transactions originating from recognized organizations, and verify their authenticity using advanced algorithms. The concept also can also evaluate whether the user is utilizing financial products restricted to eligible classes, such as VA loans or military credit cards, and verifies these products with issuing institutions.

Furthermore, the concept can assess whether the user's financial account is linked with institutions offering products restricted to specific user classes. The concept can identify accounts, cross-reference the identified accounts with a database of restricted financial products, and validate account details. The concept can analyze the user's transaction history for transactions made at restricted geographic locations, such as military bases or government facilities, and assesses patterns indicative of military affiliation.

Additionally, the concept can analyze the user's transaction history to identify recurring transactions that suggest the application of eligible discounts. The concept can employ pattern recognition algorithms and cross-references transactions with known discount rates. To enhance the accuracy of identifying eligible transactions, the concept can apply machine learning algorithms to analyze transaction histories comprehensively and integrates findings from various data points to provide a holistic evaluation.

The concept can synthesize the outputs from these analyses into a probability score. For example, the concept can normalize the data, apply weighting factors, and compute a final score indicating a likelihood that the user belongs to the eligible class. When the probability score meets a predefined threshold, the system can prompt the user to confirm their membership, ensuring the accuracy of the assessments.

Additionally, the concept can facilitate communication with vendors to apply discounts based on the user's eligibility. For example, the concept can send requests to vendors to offer future discounts or apply retroactive discounts to completed transactions when certain probability score thresholds are met.

The concept described herein is rooted in computer technology and provides a technical solution, specifically within the domain of online financial services, addressing and overcoming technical problems that arise in the realm of online banking and the online components of financial services.

The concept involves a novel approach to processing and organizing data in a specific and innovative manner, involving steps of data collection, cross-referencing, validation, and probability scoring, which are integrated into a cohesive system that performs functions beyond the capabilities of traditional methods. Moreover, several of these steps can be performed simultaneously, thereby improving the functioning of a computer performing the steps involved in assessing the probability of the user belonging to a class of users eligible for discounts.

By employing advanced algorithms and machine learning techniques, the concept processes user data, transaction histories, financial product usage, and geographic transaction patterns to generate a probability score indicating discount eligibility. This approach addresses the unique challenges of verifying user eligibility in a secure and efficient manner within the context of online financial services. The system’s ability to cross-reference multiple data points, apply weighting factors, and generate actionable insights exemplifies its technical nature and its significant improvement over existing technologies.

Furthermore, the concept facilitates communication with online vendors to apply discounts based on the computed probability scores, ensuring that eligible users receive their entitled benefits. This proactive and automated interaction with external systems exemplifies the practical application of the concept within the framework of online financial services.

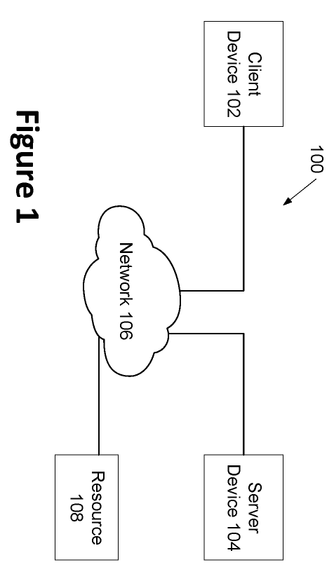

FIG. 1 illustrates a schematic of a computer system 100 designed for assessing a probability of a user belonging to a class of users eligible for discount. As depicted in FIG. 1, the computer system 100 encompasses a computing environment comprised of one or more client devices 102 connected to a server device 104 via a network 106.

The one or more client devices 102 can be computing devices equipped with processors and memory, capable of initiating various tasks related to assessing a probability of a user belonging to a class of users eligible for discount. These client devices 102 can encompass a variety of computing devices such as desktop computers, laptops, integrated development environment systems, or other hardware capable of interfacing with the components of the network 106.

The server device 104, which may be a single server or a collection of servers within a server farm, possesses computing resources including processors and data storage repositories, enabling the one or more client devices 102 to engage in complex tasks involving the receipt and processing of data from a variety of sources. The analytical capabilities of the server device 104 are directed at assessing a probability of a user belonging to a class of users eligible for discount.

Although depicted as physically distinct devices, the one or more client devices 102 and the server device 104 can share resources such as processors and databases, enabling a unified approach to analyzing interactions and formulating response strategies. In certain embodiments, the server device 104 may also incorporate resources from a third-party vendor or contracting partner, depicted as resource 108. These resources 108 can include one or more generative pre-trained transformers or other algorithms or features to improve the functionality of the modules described herein.

The network 106 serves as the underlying communication framework, facilitating data exchange and interaction between the one or more client devices 102 and the server device 104. Additionally, the network 106 enables the reliable and secure transmission of data and commands within computer system 100, supporting real-time analysis based on the most current reported asset prices and other pertinent economic indicators from the resource 108.

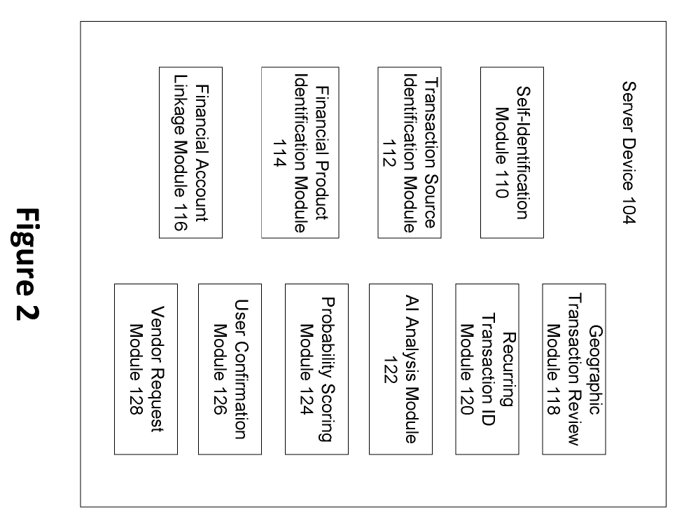

As shown in FIG. 2, the server device 104 can comprise one or more modules, with each module configured as a specialized component adapted to perform specific computational processing tasks within the computer system 100. In certain embodiments, the server device 104 can incorporate the following modules: self-identification module 110, transaction source identification module 112, financial product identification module 114, financial account linkage module 116, geographic transaction review module 118, recurring transaction identification module 120, AI analysis module 122, probability scoring module 124, user confirmation module 126, vendor request module 128. Together, these modules constitute a comprehensive sub-system within the server device 104, facilitating assessing a probability of a user belonging to a class of users eligible for discount.

The self-identification module 110 is configured to determine if a user has self-identified as belonging to a class of users eligible for discount. In embodiments, the self-identification module 110 can be configured to perform a series of steps to ascertain the self-identified status of the user. Initially, the self-identification module 110 can assess the user’s profile data stored within the system’s database, which in some cases may include information provided by the user during account creation or through subsequent updates.

For example, the self-identification module 110 may query the user profile for explicit declarations indicating membership in a discount-eligible class. Such declarations may include selections from predefined categories such as veteran, senior citizen, student, educator, first responder, healthcare worker, government employee, nonprofit organization employee, membership club member, or employee of a particular company. If the user has checked a box or selected an option corresponding to any of these categories, the self-identification module 110 can record a positive identification.

In some embodiments, the self-identification module 110 can cross reference the user's profile with any linked accounts or third-party verification services. For example, the module may check for affiliations with organizations like ID.me, or other entity confirming the user's eligibility. If such affiliations are detected and verified, the self-identification module 110 can update the user’s profile accordingly.

In some embodiments, the self-identification module 110 can analyze uploaded documentation within the user's profile or records. For example, the self-identification module 110 can scan a user's records for documents such as military IDs, student IDs, or employment verification letters. Advanced image recognition and text extraction algorithms can be utilized to authenticate these documents. For instance, if a user uploads a military ID, the self-identification module 110 can extract relevant details such as name, rank, and service number, and for comparison against known patterns and formats to confirm authenticity.

In some embodiments, the self-identification module 110 can use information provided by the user to determine an age of the user, a residence of the user, and other identifying information which may be useful in determining whether the user belongs to a class of users eligible for discount. This additional information can be used to further refine the accuracy of the self-identification process by incorporating age-specific discounts for senior citizens, residency-based discounts, or other demographic-based eligibility criteria.

Upon completing these steps, the self-identification module 110 can generate a self-identification status for the user, which can be stored within the user’s profile for access by other modules within the system for further processing. The self-identification module 110 can also be configured to log all actions and decisions for audit purposes, ensuring transparency and traceability of the self-identification process.

For example, consider a user who is a veteran seeking to open a new financial account. During account creation, the user selects the "veteran" option from a dropdown menu in the profile section. The self-identification module 110 can record this selection and mark the user’s profile with a veteran status. Additionally, during the account creation process the user uploads a scanned copy of their military ID. The self-identification module 110 can employ OCR technology to extract and verify the details from the ID, confirming its authenticity. Thereafter, data collected by the self-identification module 110 can be used to determine a score indicating a probability of the user belonging to the class of users eligible for discount.

The transaction source identification module 112 is configured to determine if the user has been on the receiving end of a financial transaction from an organization restricted to a class of users eligible for discount. In embodiments, the transaction source identification module 112 can be configured to perform a sequence of steps to identify and verify such transactions, ensuring that the user qualifies for specific discounts based on their financial interactions with eligible organizations.

For example, the transaction source identification module 112 can be configured to retrieve the user's transaction history from the system’s database, which includes all recorded financial transactions. As part of the analysis, the transaction source identification module 112 can filter these transactions to identify those originating from recognized organizations provide payments or other benefits to specific user classes. These organizations may include military payroll services, veterans assistance services, educational institutions, government agencies, or nonprofit organizations.

Thereafter, the transaction source identification module 112 can match the filtered transactions against a predefined list of eligible organizations stored a related database. This list can be regularly updated and maintained to include entities, such as the Department of Veteran Affairs, military payroll departments, educational grant providers, and similar entities. The transaction source identification module 112 can cross-reference the transaction details with this list to identify qualifying transactions.

Further, in some embodiments, the transaction source identification module 112 can verify the authenticity of these transactions. Verification may involve checking the transaction metadata, such as the originator's identification, transaction timestamps, and amounts. Advanced verification algorithms can be employed to ensure that the transactions are legitimate and originated from the eligible organizations. For instance, the transaction source identification module 112 may use cryptographic techniques to validate transaction signatures or API calls to verify transaction records with the originating institutions. The transaction source identification module 112 can also be configured to maintain a log of all identified transactions and verification steps for audit and compliance purposes.

Consider a user who has received payments from the Department of Veteran Affairs (VA). The transaction source identification module 112 retrieves the user's transaction history and filters it to isolate transactions from the VA. The transaction source identification module 112 then cross-references these transactions with the list of eligible organizations, confirming that the VA is included. To verify authenticity, the transaction source identification module 112 checks the transaction metadata, ensuring the payments are consistent with typical VA disbursements, such as disability benefits or GI Bill payments. This information can then be used by the system to determine the user's eligibility for veteran-specific discounts.

The financial product identification module 114 is configured to determine if a user is utilizing a financial product restricted to a class of users eligible for discount. In embodiments, the financial product identification module 114 can validate such financial products, ensuring the accurate assessment of user eligibility for various discounts.

In operation, the financial product identification module 114 can assess the user’s financial account information, which can include details of all linked financial products. For example, the financial product identification module 114 can scan this information to identify any financial products that are restricted to specific user classes. Such products may include VA loans, military credit cards, and other specialized financial instruments.

Thereafter, the financial product identification module 114 can match the identified financial products against a database of restricted financial products maintained by the system, which can include detailed descriptions and criteria for products which are available exclusively to veterans or issued to active-duty service members and their families.

Additionally, the financial product identification module 114 can verify the product details, such as account numbers, issue dates, and usage patterns, against records from the issuing financial institutions. Verification may involve API calls or secure data exchanges with banks, credit unions, and other financial entities to confirm that the user holds an active, qualifying financial product. For instance, the financial product identification module 114 may verify a VA loan by checking loan origination and servicing records with the Department of Veterans Affairs or associated lenders.

Upon completing these steps, the financial product identification module 114 can update the user’s profile with verified financial product information, which can be utilized by other modules within the system to assess discount eligibility. The financial product identification module 114 can also maintain a detailed log of the identification and verification processes to ensure compliance and facilitate audits.

Consider a user who has a VA loan and a military credit card. The financial product identification module 114 can retrieve the user’s financial account data and identify the VA loan and military credit card among the listed accounts. The financial product identification module 114 can then cross-reference these products to confirm that both the VA loan and the military credit card are restricted to eligible user classes. To validate these products, the financial product identification module 114 can contact the issuing financial institutions—verifying the VA loan through a secure data exchange and confirming the military credit card with the issuing bank. Upon successful verification, the financial product identification module 114 can update the user’s profile.

The financial account linkage module 116 is configured to determine if a financial account of the user is linked with a financial institution or account restricted to a class of users eligible for discount. In embodiments, the financial account linkage module 116 can be configured to identify and verifies such financial accounts, ensuring the accurate assessment of user eligibility for discounts based on their banking relationships.

Initially, the financial account linkage module 116 can assess the user’s financial account data, which can include details of all linked accounts. For example, the financial account linkage module 116 can scan this data to identify accounts associated with financial institutions known to offer products restricted to specific user classes. Examples of such accounts include Wells Fargo military banking accounts, USAA accounts, Navy Federal credit union accounts, as well as accounts exclusive to senior citizens or members of particular organizations or groups.

Thereafter, the financial account linkage module 116 can cross-reference the identified accounts with a database of restricted financial accounts maintained by the system, which can include detailed descriptions and criteria for accounts such as military banking accounts, which are available exclusively to active-duty service members, veterans, and their families, and accounts for senior citizens offered by various financial institutions.

Additionally, the financial account linkage module 116 can validate the account details, such as account numbers, holder information, and account activity, against records from the financial institutions. This may involve secure API calls or data exchanges with banks and credit unions to confirm that the user holds an active, qualifying account. For example, the module may verify a Wells Fargo military banking account by checking membership records and account status with Wells Fargo.

Upon completing these steps, the financial account linkage module 116 Date the user’s profile with verified financial account information. This information can then be utilized by other modules within the system to assess discount eligibility. The financial account linkage module 116 can also maintain detailed logs of the identification and verification processes to ensure compliance

Consider a user who has a Wells Fargo military banking account. The financial account linkage module 116 can retrieve the user’s financial account data and identify the Wells Fargo military banking account among the listed accounts. The financial account linkage module 116 then cross-references this account, confirming that the military banking account is restricted to eligible user classes. To validate this account, the module may contact the financial institution where the account is held through a secure data exchange, verifying the account details. Upon successful verification, the financial account linkage module 116 can update the user’s profile, indicating possession of a banking account restricted to a particular class of users, in this case active-duty military members, veterans, or dependents thereof.

The geographic transaction review module 118 is configured to review the transaction history of a user to identify one or more transactions made at geographic locations with access limited to a class of users eligible for discounts. In embodiments, the geographic transaction review module 118 can play an important role in determining user eligibility by analyzing the geographical context of transactions, providing insight into the user's potential affiliation with specific groups.

Initially, the geographic transaction review module 118 can retrieve the user's transaction history, including detailed information on transaction dates, amounts, and locations. The geographic transaction review module 118 can identify transactions that occur in locations known to have restricted access, such as military bases, government facilities, or exclusive resorts. This identification can be facilitated by a comprehensive database of restricted locations, which the geographic transaction review module 118 can reference to match transaction data.

In some embodiments, the geographic transaction review module 118 can analyze the frequency and pattern of transactions. For example, if a user frequently makes purchases on a military base, this pattern may indicate that the user is an active-duty service member or a dependent. The geographic transaction review module 118 employs geolocation data and transaction metadata to verify the user's presence at these locations, ensuring accurate identification.

In one example, a user makes multiple purchases at a commissary located on a military base. The geographic transaction review module 118 can identify the commissary's location as restricted to military personnel and dependents, then cross-reference the user's transaction history to confirm a pattern consistent with regular base access. This information can be recorded and used to enhance the probability score indicating the user's eligibility for military-specific discounts.

In another example, the geographic transaction review module 118 can identify significant gaps between transactions, which may suggest a military deployment. For instance, a user may have consistent transaction activity that suddenly pauses for several months, potentially indicating a deployment. If the geographic transaction review module 118 detects transactions near an airport shortly before the gap, this pattern could further support the hypothesis of a military campaign. Such contextual analysis allows the geographic transaction review module 118 to provide a nuanced assessment of the user's eligibility.

Furthermore, the geographic transaction review module 118 can cooperate with the AI analysis module 122 to refine its evaluations, which can apply advanced machine learning algorithms to analyze broader transaction patterns and predict eligibility with higher accuracy. Through this analysis, the geographic transaction review module 118 can ensure a thorough and precise analysis of the user's transaction history in relation to restricted or limited access geographic locations, thereby indicating that the user belongs to the class of users normally granted access to such geographic locations.

The recurring transaction identification module 120 is configured to analyze the transaction history of a user to identify recurring transactions that may indicate the application of discounts limited to specific classes of users. In embodiments, the recurring transaction identification module 120 is useful in determining user eligibility by examining the consistency and value of periodic payments, providing evidence of potential discount applications.

Initially, the recurring transaction identification module 120 can retrieve the user's transaction history, focusing on transactions that recur at regular intervals, such as monthly, quarterly, or annually. In doing so, the recurring transaction identification module 120 can employ pattern recognition algorithms to detect transactions with consistent frequencies and amounts. These transactions can be flagged for further analysis to determine if they fall within the scope of eligible discount programs.

Thereafter, the recurring transaction identification module 120 can cross-reference the flagged transactions with a database of vendors known to offer discounts to specific user classes, such as military personnel, senior citizens, or students. The recurring transaction identification module 120 can identify the nature of these recurring transactions, such as phone plans, Internet service providers, streaming services, utility bills, insurance, gym memberships, mortgage payments, cable or satellite TV services, credit card fees, subscription boxes, car payments, health and wellness services, and student loan payments, among others. By comparing the transaction amounts to standard rates and known discount rates, the recurring transaction identification module 120 can assess whether a discount has likely been applied.

In one example, a user has a monthly phone plan from a major carrier known to offer military discounts. The recurring transaction identification module 120 can identify identifies the regular monthly payment and compare the regular payment amount to the carrier's standard pricing for similar plans. If the regular payment amount is consistent with a rate that includes a military discount, the recurring transaction identification module 120 can conclude that the discount has been applied to the user's account.

Furthermore, the recurring transaction identification module 120 may detect variations in transaction values that still fall within the range of known discount rates, accommodating for minor fluctuations due to taxes or fees. These variations can be analyzed to ensure the accuracy of the module's assessments, reinforcing the determination of discount application.

In some embodiments, the recurring transaction identification module 120 cooperates with the AI analysis module 122 to enhance its evaluations, which can utilize advanced machine learning algorithms to analyze broader patterns across multiple users, improving the predictive accuracy of recurring transaction identification. Through this analysis the recurring transaction identification module 120 can provide a comprehensive review of periodic payments, identifying recurring transactions that suggest the application of eligible discounts.

The AI analysis module 122 is configured to enhance the accuracy and efficiency of identifying transactions that indicate user eligibility for specific discounts. In embodiments, the AI analysis module 122 employs advanced machine learning algorithms and data analytics to analyze transaction histories comprehensively, for example, to assist in identifying transactions made at geographic locations with restricted access and recurring transactions with values consistent with applied discounts for eligible user classes.

In embodiments, the AI analysis module 122 can ingest the user's transaction history data, including timestamps, transaction amounts, and geolocation metadata. The AI analysis module 122 can apply geospatial analysis techniques to identify transactions occurring at geographic locations restricted to certain user classes, such as military bases or government facilities. In some embodiments, the AI algorithms can utilize a pre-defined database of restricted locations to match and validate these transactions, ensuring high precision in the identification process.

Additionally, the AI analysis module 122 can employ temporal pattern recognition to detect recurring transactions within the user's transaction history. By analyzing the frequency and regularity of payments, such as monthly subscriptions or utility bills, the AI analysis module 122 can identify consistent patterns indicative of recurring financial commitments. The AI analysis module 122 can cross-reference these transactions with a database of vendors known to offer discounts to specific user classes, evaluating whether the transaction values align with known discounted rates.

An exemplary application of the AI analysis module 122 involves a user who makes regular purchases at a commissary located on a military base and maintains a monthly phone plan with a carrier offering military discounts. The module identifies the geographic location of the commissary transactions, confirming restricted access consistent with military affiliation. Simultaneously, it detects the recurring phone plan payments, comparing them to the carrier’s standard and discounted rates. By integrating geospatial and temporal data, the AI module concludes that the user likely benefits from a military discount.

The AI analysis module 122 can integrate its findings with other modules, such as the geographic transaction review module 118 and the recurring transaction identification module 120 to allow for a comprehensive evaluation of the user's transaction history, through machine learning to refine and validate the identification of eligible transactions.

Furthermore, the AI analysis module 122 can employ anomaly detection techniques to identify outliers and irregularities in the transaction history that may suggest additional discount eligibility. For instance, a sudden gap in transactions followed by a pattern consistent with military deployment and return can be flagged for further review. This dynamic analysis capability ensures that the AI analysis module 122 can account for complex and varied transaction behaviors.

The probability scoring module 124 configured to synthesize the outputs from various identification modules into a comprehensive score that indicates the probability of a user belonging to a class of users eligible for a discount. In embodiments, the probability scoring module 124 aggregates data, applies weighting factors, and computes a final probability score, thereby enabling the computer system 100 to make informed decisions about user eligibility for discounts.

Upon receiving inputs from the self-identification module 110, transaction source identification module 112, financial product identification module 114, financial account linkage module 116, geographic transaction review module 118, and recurring transaction identification module 120, the probability scoring module 124 initiates its process by normalizing the data. Each input is standardized to ensure consistency and comparability across different data types and sources.

In some embodiments, the probability scoring module 124 assigns a weighting factor to the output of each identification module. These weighting factors can be determined based on the relative importance and reliability of the data provided by each module. For example, data from the self-identification module 110, which directly indicates user self-disclosure, may be assigned a higher weighting factor than data from the geographic transaction review module 118, which might offer indirect evidence of user eligibility. The specific weighting factors can be adjusted based on empirical analysis and system requirements to optimize the scoring accuracy.

In some embodiments, a multiplier can be applied when the results of a first module confirm the results of a second module. For example, if the financial product identification module 114 yields a high probability score due to an association with a financial account only available to veterans and their dependents, and the transaction source identification module 112 confirms transactions from veteran-specific organizations, both scores can be multiplied by a multiplier to influence the final probability score.

The probability scoring module 124 can aggregate these weighted scores to compute a cumulative probability score. This score can be represented as a numerical value within a predefined range, such as 1 to 100, with higher score within this range indicating a higher probability that the user belongs to the class of users eligible for the discount. For example, a user with consistent positive indicators across all modules might receive a score of 90 or more, signifying a very high probability of eligibility.

In some embodiments, the probability scoring module 124 can incorporate a threshold mechanism to facilitate decision-making processes. Scores above a certain threshold may trigger actions such as notifying the user of potential discounts or directly applying for discounts with vendors. Conversely, scores below the threshold may prompt further verification or additional data collection.

The user confirmation module 126 is configured to prompt the user to confirm their membership in a class of users eligible for discounts when the calculated probability score meets or exceeds a predefined threshold. In embodiments, the user confirmation module 126 can aid in ensuring that the system’s assessments are validated by the user, thereby enhancing the accuracy and reliability of discount eligibility determinations.

Upon receiving a high probability score from the probability scoring module 124, the user confirmation module 126 can initiate a confirmation process. The user confirmation module 126 can generate a prompt that is sent to the user through their preferred communication channel, which may include email, mobile notification, or an in-app message. The prompt can request the user to confirm their membership in the identified eligible class, such as military personnel, senior citizens, or students.

For instance, consider a user who has a banking account exclusively available to service members, veterans, and their dependents. Additionally, this user appears to be receiving military discounts from their Internet service provider and their gym membership. Upon these indications, the user confirmation module 126 sends a prompt to the user, stating: “We have identified that you may be eligible for military discounts based on your current account and transactions. Please confirm if you are a service member, veteran, or dependent.”

If the user confirms their membership in the specified class, the user confirmation module 126 can record this confirmation in the user’s profile. This verified status can then be used by the computer system 100 to facilitate automatic discount applications and streamline future eligibility assessments. Additionally, the confirmation data can be securely stored and logged for audit and verification purposes.

Furthermore, upon confirmation of membership, the user confirmation module 126 can inquire whether the user would like information about additional products and discounts available to their class. If the user consents, the user confirmation module 126 can provide targeted information regarding various discounts, such as reduced rates on insurance, special loan offers, or other financial products tailored to military personnel.

In some embodiments, the user confirmation module 126 can also integrate with other system components to ensure a seamless user experience. For instance, upon user confirmation, the user confirmation module 126 can interface with the vendor request module 128 to inform vendors of the user’s confirmed status, enabling them to apply applicable discounts directly.

The vendor request module 128 is configured to facilitate communication with vendors to ensure users receive applicable discounts based on their eligibility status. In embodiments the vendor request module 128 operates by sending requests to vendors to either offer discounts on future transactions or apply retroactive discounts to completed transactions when certain probability score thresholds are met.

Initially, the vendor request module 128 can receive a probability score from the probability scoring module 124. When this score meets or exceeds a predefined threshold, the vendor request module 128 can initiate a process to request a discount for future transactions. In the first step, the vendor request module 128 can generate a request that includes relevant user details, such as membership status, identified class, and transaction history

In some embodiments, the vendor request module 128 can transmit the request to the vendor through a secure communication channel, which may include API calls, email, or electronic data interchange (EDI). The request can specify that the user eligible for a discount based on their score and requests the vendor to apply the discount to future transactions involving the user. For example, if the user frequently shops at a retailer known to offer military discounts, the vendor request module 128 can send a request asking the retailer to apply the military discount on the user’s upcoming purchases.

Additionally, the vendor request module 128 can monitor the vendor’s response and updates the user’s profile accordingly. If the vendor confirms the application of the discount, this information can be recorded and used to adjust future interactions and eligibility assessments. The vendor request module 128 can also log communications for audit and compliance purposes.

In some embodiments, when the score meets or exceeds a different threshold, the vendor request module 128 can initiate a process to request a retroactive discount on completed transactions. This higher threshold can indicate an even greater likelihood that the user is eligible for the discount. In this scenario, the vendor request module 128 can generate a request that includes detailed information about the completed transactions, such as transaction dates, amounts, and the identified class of the user.

In some embodiments, the vendor request module 128 can send a request to the vendor, specifying the user’s eligibility and requesting a retroactive discount application. For instance, if the user has made past purchases at a retailer without receiving a military discount, the vendor request module 128 can ask the retailer to review these transactions and apply the discount retroactively. This process can involve recalculating the transaction amounts and issuing a refund or credit to the user’s account.

The vendor request module 128 can also track the vendor’s response to the retroactive discount request. If the vendor agrees to apply the retroactive discount, the vendor request module 128 can update the user’s transaction records to reflect the adjusted amounts.

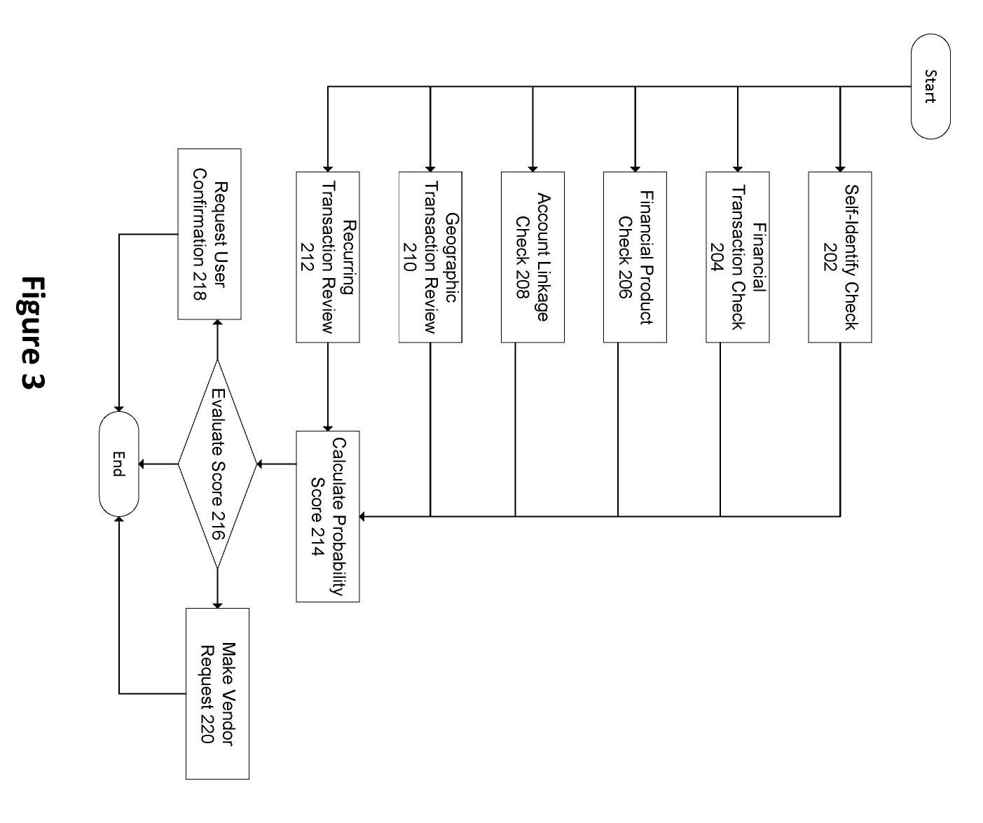

Referring to FIG. 3, an example method 200 is shown for assessing a probability of a user belonging to a class of users eligible for discount. The method 200 comprises a sequence of steps for collecting and processing transaction data designed to assess the probability that a user belongs to a class of users eligible for discounts, and in some embodiments can be implemented by the computer system 100. For example, the server device 104 can be configured to interact with the client device 102 and the resource 108 through the network 106 to facilitate the execution of the steps outlined in method 200.

The method can begin with step 202, wherein the system determines if the user has self-identified as belonging to a discount-eligible class. This is followed by step 204, which involves determining if the user has been on the receiving end of financial transactions from organizations restricted to the eligible class.

In step 206, the system evaluates if the user is utilizing financial products restricted to the eligible class, such as VA loans or military credit cards. Step 208 involves assessing if the user's financial account is linked with institutions or accounts restricted to the eligible class, including but not limited to banking accounts restricted to members of a class eligible for discount.

Step 210 enables the system to review the user's transaction history to identify transactions made at geographic locations with restricted access, such as military bases or government facilities. Concurrently, in step 212, the system examines the transaction history to identify at least one recurring transaction with a value consistent with applied discounts for the eligible class.

These steps (202, 204, 206, 208, 210, 212) can be performed in any order or simultaneously, ensuring comprehensive data collection before proceeding to step 214, In step 214, the system integrates the data from the previous steps to determine a score indicating the probability of the user belonging to the eligible class. The scoring may involve multiplying the results of each identification step by a weighting factor, tailored to reflect the relative significance of each factor.

Upon calculating the probability score, step 216 is executed to determine if the score meets or exceeds predefined thresholds. Depending on the outcome of this evaluation, the method 200 can optionally proceed to one or both of the following steps. If the score meets or exceeds a first threshold, the system executes step 218, prompting the user to confirm their membership in the eligible class.

Alternatively, if the score meets or exceeds a second threshold, the system proceeds to step 220. In this step, the system can send a request to the relevant vendor to offer the user a discount on future transactions or to apply a retroactive discount to completed transactions. This ensures that users who are likely to be eligible for discounts receive the financial benefits they are entitled to, either proactively or retrospectively.

As an example, consider use of the method 200 to determine if a user is eligible for a military discount. The user in question is a 23-year-old individual who regularly uses a debit card for transactions. The following steps illustrate how the method assesses the user's eligibility based on their transaction history and other relevant data.

Initially, in step 202, the self-identification module 110 queries the user’s profile to determine if the user has explicitly declared membership in a discount-eligible class, such as military personnel. In this instance, the user has not self-identified, however the user's age is relevant in the determination, particularly in combination with the debit card usage, and therefore may be factored into determination of the probability score.

Proceeding to step 204, the system examines the user's transaction history to identify any financial transactions from organizations restricted to military personnel. The user's regular use of a debit card includes transactions made at a commissary located at a naval base in Norfolk, Virginia. This location is recognized as a restricted access facility, typically available only to military personnel and their dependents.

In step 206, the system evaluates whether the user utilizes any financial products specifically designed for military personnel. Next, in step 208, the system determines if the user’s financial account is linked with financial institutions that cater to military personnel. While this example does not specify any particular financial product or account usage, the module cross-references the user’s account details for any such indications.

In step 210, the system analyzes the user's transaction history for geographic indicators of military affiliation. The user has transactions at the naval base in Norfolk, Virginia, and two transactions in Bahrain. The geographic transaction review identifies a pattern consistent with military deployment, particularly when the user's debit card usage pauses for four months, followed by transactions in Bahrain, and then another two-month pause. This pattern is typical of military personnel undergoing deployment and subsequent return.

In step 212, the system examines the user’s transaction history to identify any recurring transactions with values consistent with military discounts. The regularity of the debit card usage before and after the deployment period supports the presence of stable, recurring expenses, although specific discount-related transactions are not identified in this example.

Once these steps are completed, the system proceeds to step 214. The module integrates the data from the prior steps, assigning appropriate weighting factors to the identified transactions and patterns. The presence of transactions at restricted military locations and the deployment-related pauses, as well as the user’s age significantly contribute to a high probability score, indicating a strong likelihood that the user belongs to the military class.

In step 216, the calculated probability score is assessed against predefined thresholds. Given the strong indicators, the score meets or exceeds the first threshold. Consequently, the method proceeds to step 218. The system prompts the user to confirm their military status, ensuring the accuracy of the assessment.

If the user confirms their military status, the method may proceed to step 220. The system sends a request to relevant vendors, such as the user's Internet service provider or gym, to offer military discounts on future transactions or apply retroactive discounts to previous transactions.

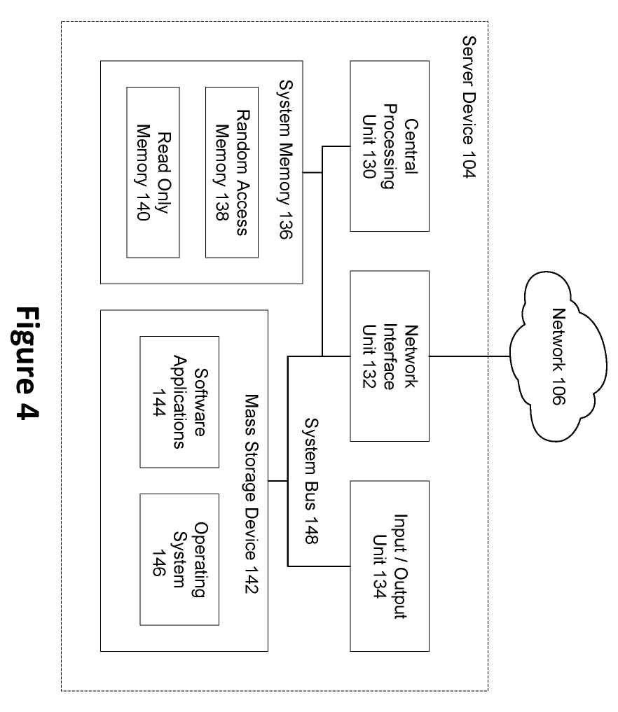

As illustrated in the embodiment of FIG. 4, the example server device 104, which provides the functionality described herein, can include at least one central processing unit (“CPU”) 130, a system memory 136, and a system bus 148 that couples the system memory 136 to the CPU 130. The system memory 136 includes a random access memory (“RAM”) 138 and a read-only memory (“ROM”) 140. A basic input/output system containing the basic routines that help transfer information between elements within the computer system 100, such as during startup, is stored in the ROM 140. The computer system 100 further includes a mass storage device 142. The mass storage device 142 can store software instructions and data. A central processing unit, system memory, and mass storage device similar to that shown can also be included in the other computing devices disclosed herein.

The mass storage device 142 is connected to the CPU 130 through a mass storage controller (not shown) connected to the system bus 148. The mass storage device 142 and its associated computer-readable data storage media provide non-volatile, non-transitory storage for the computer system 100. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 104.

According to various embodiments of the invention, the computer system 100 may operate in a networked environment using logical connections to remote network devices through network 106, such as a wireless network, the Internet, or another type of network. The network 106 provides a wired and/or wireless connection. In some examples, the network 106 can be a local area network, a wide area network, the Internet, or a mixture thereof. Many different communication protocols can be used.

The server device 104 may connect to network 106 through a network interface unit 132 connected to the system bus 148. It should be appreciated that the network interface unit 132 may also be utilized to connect to other types of networks and remote computing systems. The server device 104 also includes an input/output controller 134 for receiving and processing input from a number of other devices, including a touch user interface display screen or another type of input device. Similarly, the input/output controller 134 may provide output to a touch user interface display screen or other output devices.

As mentioned briefly above, the mass storage device 142 and the RAM 138 of the server device 104 can store software instructions and data. The software instructions include an operating system 146 suitable for controlling the operation of the server device 104. The mass storage device 142 and/or the RAM 138 also store software instructions and applications 144, that when executed by the CPU 130, cause the server device 104 to provide the functionality of the computer system 100 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer-implemented method for assessing a probability of a user belonging to a class of users eligible for a discount, comprising:
ingesting, by an artificial intelligence algorithm executed by a computing device, a transaction history of the user to train the artificial intelligence algorithm, the transaction history including timestamps, amounts, and locations associated with transactions in the transaction history;
reviewing, by the artificial intelligence algorithm executed by the computing device, the transaction history of the user using a geospatial analysis to identify one or more transactions made at a geographic location with access limited to the class of users eligible for the discount;
reviewing, by the artificial intelligence algorithm executed by the computing device, the transaction history of the user using temporal pattern recognition to identify at least one reoccurring transaction having a value consistent with an applied discount limited to the class of users eligible for the discount;
determining, by the artificial intelligence algorithm executed by the computing device, a score indicating the probability of the user belonging to the class of users eligible for the discount; and
when the score meets a threshold, automatically sending, by the computing device, a request to a vendor to apply a retroactive discount to a completed transaction of the user.

2. The method of claim 1, further comprising, when the score meets or exceeds a second threshold, automatically prompting, by the computing device, the user to confirm membership in the class of users eligible for the discount.

3. The method of claim 1, further comprising, when the score meets or exceeds a second threshold, automatically sending, by the computing device, a request to the vendor to offer the user the discount on a future transaction.

4. The method of claim 1, wherein the class of users eligible for the discount includes at least one of veterans, senior citizens, students, educators, first responders, healthcare workers, government employees, employees of a nonprofit organization, members of a membership club, or employees of a particular company.

5. The method of claim 1, wherein the geographic location with access limited to the class of users eligible for the discount includes at least one of a military base or a government facility.

6. The method of claim 1, further comprising determining, by the artificial intelligence algorithm executed by the computing device, if the user has self-identified as belonging to the class of users eligible for the discount.

7. The method of claim 1, further comprising determining, by the artificial intelligence algorithm executed by the computing device, if the user has been on a receiving end of a financial transaction from an organization restricted to the class of users eligible for the discount.

8. The method of claim 1, further comprising determining, by the artificial intelligence algorithm executed by the computing device, if the user is using a financial product restricted to the class of users eligible for the discount.

9. The method of claim 1, further comprising determining, by the artificial intelligence algorithm executed by the computing device, if a financial account of the user is linked with a financial institution or account restricted to the class of users eligible for the discount.

10. The method of claim 1, further comprising refining, by the artificial intelligence algorithm executed by the computing device, identification of the one or more transactions made at the geographic location and the at least one reoccurring transaction by employing anomaly detection techniques to identify outliers and irregularities in the transaction history.

11. A system for assessing a probability of a user belonging to a class of users eligible for a discount, comprising:
a computing device comprising a processor and a non-transitory computer-readable storage medium storing instructions that, when executed by the processor, cause the computing device to:
ingest, by an artificial intelligence algorithm, a transaction history of the user to train the artificial intelligence algorithm, the transaction history including timestamps, amounts, and locations associated with transactions in the transaction history;
review, by the artificial intelligence algorithm, the transaction history of the user using a geospatial analysis to identify one or more transactions made at a geographic location with access limited to the class of users eligible for the discount;
review, by the artificial intelligence algorithm, the transaction history of the user using temporal pattern recognition to identify at least one reoccurring transaction having a value consistent with an applied discount limited to the class of users eligible for the discount;
determine, by the artificial intelligence algorithm, a score indicating the probability of the user belonging to the class of users eligible for the discount; and
when the score meets a threshold, automatically send a request to a vendor to apply a retroactive discount to a completed transaction of the user.

12. The system of claim 11, wherein the instructions further cause the computing device to, when the score meets or exceeds a second threshold, automatically prompt the user to confirm membership in the class of users eligible for the discount.

13. The system of claim 11, wherein the instructions further cause the computing device to, when the score meets or exceeds a second threshold, automatically send a request to the vendor to offer the user the discount on a future transaction.

14. The system of claim 11, wherein the class of users eligible for the discount includes at least one of veterans, senior citizens, students, educators, first responders, healthcare workers, government employees, employees of a nonprofit organization, members of a membership club, or employees of a particular company.

15. The system of claim 11, wherein the geographic location with access limited to the class of users eligible for the discount includes at least one of a military base or a government facility.

16. The system of claim 11, wherein the instructions further cause the computing device to determine, by the artificial intelligence algorithm, if the user has self-identified as belonging to the class of users eligible for the discount.

17. The system of claim 11, wherein the instructions further cause the computing device to determine, by the artificial intelligence algorithm, if the user has been on a receiving end of a financial transaction from an organization restricted to the class of users eligible for the discount.

18. The system of claim 11, wherein the instructions further cause the computing device to determine, by the artificial intelligence algorithm, if the user is using a financial product restricted to the class of users eligible for the discount.

19. The system of claim 11, wherein the instructions further cause the computing device to determine, by the artificial intelligence algorithm, if a financial account of the user is linked with a financial institution or account restricted to the class of users eligible for the discount.

20. The system of claim 11, wherein the instructions further cause the computing device to refine, by the artificial intelligence algorithm, identification of the one or more transactions made at the geographic location and the at least one reoccurring transaction by employing anomaly detection techniques to identify outliers and irregularities in the transaction history.
